(19) United States
(12) Patent Application Publication
(10) Pub. No.: US 2026/0081275 A1
(43) Pub. Date: Mar. 19, 2026

(54) ROTOR AND METHOD FOR PRODUCING SAME

(71) Applicant: Panasonic Intellectual Property Management Co., Ltd., Osaka (JP)

(72) Inventors: TADAYOSHI TAKAHASHI, Osaka (JP); TOMOHIRO UEDA, Osaka (JP)

(21) Appl. No.: 19/117,874

(22) PCT Filed: Aug. 22, 2023
(86) PCT No.: PCT/JP2023/030172

§ 371 Date: Apr. 2, 2025

(30) Foreign Application Priority Data
Oct. 11, 2022 (JP) 2022-163463

(51) Int. Cl. H01M 50/202; B60C 23/04; H01M 50/249

(52) U.S. Cl. CPC H01M 50/202; B60C 23/041; B60C 23/0493; H01M 50/249; H01M 2220/20

(57) ABSTRACT

A rotator includes a rotating portion and a device fixed to the rotating portion, and the device includes a substrate and a flat secondary battery connected to the substrate via a terminal. The secondary battery includes an exterior body and a positive electrode and a negative electrode disposed in the exterior body. The exterior body includes a positive electrode can and a negative electrode can. The flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

### TECHNICAL FIELD

The present disclosure relates to a rotator including a rotating portion to which a device having a flat secondary battery is fixed, and a method for producing the rotator.

### BACKGROUND ART

In a rotating portion of a factory automation device (hereinafter, referred to as FA device), a device for monitoring a state of a position of the rotating portion, such as a camera, a motor, or a drill, may be attached. In addition, a device for monitoring a state of a tire may be attached to the tire. Various proposals have been made on a method for attaching a battery used in this device.

Claim 1 of PTL 1 (Unexamined Japanese Patent Publication No. 2011-014453) describes “a method for attaching a flat battery used in a device including a substrate and attached to a rotating portion, in which the flat battery is obtained by combining a positive electrode can and a negative electrode can facing each other, the substrate and the flat battery face each other and are connected via a terminal, the electrode can, facing the substrate, out of the positive electrode can and the negative electrode can is a part where a deformation amount due to expansion of the flat battery is small, and the method comprising embedding the substrate and the flat battery in a resin”.

Claim 1 of PTL 2 (International Publication No. WO 2017/155035) describes “a tire air pressure detection system disposed in a tire, the tire air pressure detection system including an air pressure detection device configured to detect an air pressure in the tire, and a secondary battery configured to supply power to the air pressure detection device, in which the secondary battery is a lithium secondary battery including a negative electrode having a lithium alloy as an active material and a positive electrode”.

### CITATION LIST

### Patent Literature

PTL 1: Unexamined Japanese Patent Publication No. 2011-014453
PTL 2: International Publication No. WO 2017/155035

### SUMMARY OF THE INVENTION

There are rotating portions to which various centrifugal forces are applied, such as robot arms, surveillance cameras, motors, drills, and tires of factory automation devices (FA devices). Information acquired by a sensor in this rotating portion is important, but the use of secondary batteries have been studied in order to maintain the acquired information for reasons such as sudden disconnection of an electric wiring and frequent replacement of a primary battery. In PTL 1, a method for attaching a battery to a substrate in a device attached to a rotating portion has been proposed for suppressing an influence of misalignment of a terminal from the substrate and an influence of cracking of the substrate, both of which are generated due to expansion of the battery. The substrate and the flat battery are embedded in a resin by using an electrode can, facing the substrate, out of the positive electrode can and the negative electrode can as a can having a small deformation amount due to expansion at the time of high-temperature expansion, however, the influence of charging and discharging of the secondary battery is not considered. PTL 2 proposes a lithium secondary battery in which a lithium alloy is used as a negative electrode active material for a tire air pressure detection system power source, but evaluation is performed on a unit battery. The lithium secondary battery is not evaluated in a state of being used in an actual device and being electrically connected to the substrate by the terminal.

A rotator according to the present disclosure is suitable for monitoring a state of a rotating portion without requiring battery replacement, and has high long-term reliability.

A rotator according to one aspect of the present disclosure includes a rotating portion configured to rotate about a rotation center; and a device fixed to the rotating portion. The device includes a substrate and a flat secondary battery connected to the substrate with a terminal. The flat secondary battery includes an exterior body, and a positive electrode and a negative electrode disposed in the exterior body. The exterior body includes a positive electrode can having a bottomed cylindrical shape and a negative electrode can having a bottomed cylindrical shape. The flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

A method for producing a rotator according to another aspect of the present disclosure includes preparing a rotating portion, preparing a device including a substrate and a flat secondary battery; and fixing the device to the rotating portion. The flat secondary battery is connected to the substrate with a terminal. The flat secondary battery includes an exterior body, and a positive electrode and a negative electrode disposed in the exterior body. The exterior body includes a positive electrode can having a bottomed cylindrical shape and a negative electrode can having a bottomed cylindrical shape. The flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

The present disclosure provides a rotator to which a device using a flat secondary battery is fixed, the rotator being suitable for monitoring a state of a rotating portion and having high long-term reliability.

### BRIEF DESCRIPTION OF THE DRAWINGS

FIG. 1 schematically illustrates an example of a device and a rotating portion according to a first exemplary embodiment.

FIG. 2A is a top view schematically illustrating an example of a flat secondary battery used in the device according to the first exemplary embodiment.

FIG. 2B schematically illustrates a section taken along line IIB-IIB of the flat secondary battery of FIG. 2A.

FIG. 3 is a schematic view for explaining an expansion amount of an exterior can of the flat secondary battery.

FIG. 4A schematically illustrates a configuration of an example of the device according to the first exemplary embodiment.

FIG. 4B is a schematic view for explaining an effect of the example of the device illustrated in FIG. 4A.

FIG. 4C schematically illustrates a configuration of another example of the device according to the first exemplary embodiment.

FIG. 4D schematically illustrates a configuration of still another example of the device according to the first exemplary embodiment.

FIG. 4E schematically illustrates a configuration of yet still another example of the device according to the first exemplary embodiment.

### DESCRIPTION OF EMBODIMENT

Hereinafter, exemplary embodiments according to the present disclosure will be described with reference to examples, but the present disclosure is not limited to examples to be described below. Although specific numerical values and materials may be provided as examples in the description below, other numerical values and materials may be applied as long as an effect of the present disclosure can be obtained. In this specification, the description “numerical value A to numerical value B” includes a numerical value A and a numerical value B, and can be read as “between numerical value A and numerical value B (inclusive)”. In the following description, in a case where lower limits and upper limits of numerical values related to specific physical properties, conditions, or the like are illustrated, any of the illustrated lower limits and any of the illustrated upper limits can be freely combined unless the lower limit is equal to or more than the upper limit. In the following description, in a case where examples of configuration elements or examples of methods are listed, only one of the listed examples may be used, or a plurality of examples of the listed examples may be used in combination unless otherwise specified.

### Device Attached to Rotating Portion

A device according to the present exemplary embodiment is a device attached to a rotating portion. Hereinafter, the device may be referred to as “device D”. Device (D) includes a substrate and a flat secondary battery connected to the substrate with a terminal. The flat secondary battery includes an exterior body, and a positive electrode and a negative electrode disposed in the exterior body. The exterior body includes a positive electrode can having a bottomed cylindrical shape and a negative electrode can having a bottomed cylindrical shape. The flat secondary battery is disposed such that when the flat secondary battery expands due to a high temperature in a charging state of the flat secondary battery, one of the positive electrode can and the negative electrode can having a larger expansion amount on a central axis of the exterior body faces the substrate.

Hereinafter, when the flat secondary battery expands due to the high temperature in the charging state, one of the positive electrode can and the negative electrode can having the larger expansion amount on the central axis of the exterior body may be referred to as “can A”, and the other can may be referred to as “can B”. Can A is a can facing the substrate. The can A is disposed between the can B and the substrate. When the flat secondary battery expands due to the high temperature in the charging state, in a case where the positive electrode can, out of the positive electrode can and the negative electrode can, has a larger expansion amount on the central axis of the exterior body, the positive electrode can is can A, and the negative electrode can is can B. When the flat secondary battery expands due to the high temperature in the charging state, in a case where the negative electrode can, out of the positive electrode can and the negative electrode can, has a larger expansion amount on the central axis of the exterior body, the negative electrode can is can A, and the positive electrode can is can B.

In the case of a primary battery, the battery expands when the battery is exposed to an external temperature, particularly a high temperature, in a discharging state. In the case of a secondary battery, the battery expands due to a change in an electrode due to charging and discharging, but in particular, when the secondary battery is exposed to a high-temperature environment in a fully charging state, the battery expands most. Which one of the positive electrode can and the negative electrode can is can A can be determined by comparing the expansion amount of the can when the flat secondary battery in the fully charging state is set to a high temperature (a temperature higher than 60° C.). Specifically, can A can be determined by comparing the expansion amount of the can when the flat secondary battery in the fully charging state is heated to 60° C. The temperature depends on a use environment, but is 70° C., 85° C., 105° C., 125° C., or 150° C. because an expansion amount increases at higher temperatures. It is preferable to perform the comparison at a temperature higher than an actually used temperature environment by at least plus 10° C. or more. In addition to a temperature of a surrounding environment, a temperature of the rotating portion in the device increases due to rotation and friction, and when the rotating portion is continuously operated, the temperature increases due to heat storage. A factory automation device (i.e., FA device) has a maximum surrounding environment of about 40° C. in a manned environment, and the temperature of the device reaches 70° C. or 85° C. when the device is continuously used. In addition, in a special case in the unmanned environment, the temperature reaches 105° C., 125° C., and 150° C. For example, a temperature of a drill may reach such a temperature. In the case of a tire, a temperature also reaches 105° C., 125° C., and 150° C. depending on a road surface temperature and a rotation state. A continuous use time of the tire is considerably shorter than that of the factory automation device (i.e., FA device).

In the flat secondary battery, when the expansions of the exterior cans (i.e., the positive electrode can and the negative electrode can) increase, an internal electrical contact between the electrode and the exterior can becomes insufficient to increase a resistance. Thus, battery characteristics such as a decrease in discharging capacity due to insufficient charging and a decrease in discharging current characteristics may greatly degrades. In device (D), can A having a large expansion amount faces the substrate. Thus, when can A expands, after a most expanded portion of can A comes into contact with the substrate, can A does not further expand in a thickness direction, and the expansion of can A can be suppressed by the substrate. Since the substrate has sufficient strength, deformation or cracking of the substrate does not occur. In addition, a contact area between the substrate and can A may increase due to a change with time. As a result, the internal electrical contact between the electrode and the exterior can is maintained, and the degradation of the battery characteristics can be suppressed. In addition, there is no influence on a portion connected to the substrate via the terminal due to the battery expansion. Thus, the dismounting of the connection portion does not occur. In the configuration of PTL 1, since the battery is embedded in the resin, the resin is deformed with the volume corresponding to the expansion of the battery as it is, and the force concentrates on the connection portion between the terminal and the substrate, in the connection portion is a portion where the strength thereof is weak. Thus, the connection portion comes off. In the present invention, unlike PTL 1, since both the battery and the substrate are not embedded in a resin without a gap, not only a volume change due to the expansion of the battery is allowed, but also an effect of suppressing expansion is obtained. As a result, it is possible to realize a rotator to which a highly reliable device is fixed for a long period of time.

Can A may be pushed via another member (for example, a terminal or a fixing double-sided tape) disposed between can A and the substrate.

Since a resin is not disposed between the flat secondary battery and the substrate in device (D) and a heat transfer property from the surrounding environment also decreases, the influence of thermal shock due to a temperature change on the flat secondary battery is also alleviated, which is preferable. In addition, production cost can be reduced.

The flat secondary battery (more specifically, a bottom surface of can A or a terminal connected to can A) and the substrate may come into contact with each other. Alternatively, in a state where can A does not expand, a certain interval (e.g., space) may be present between the flat secondary battery and the substrate. However, when a gap is too large (for example, when a gap more than or equal to a maximum expansion amount of can A is provided), it is not preferable since the large gap influences the dismounting between the terminal and the substrate.

The flat secondary battery may be disposed outside the substrate as viewed from a rotation center of the rotating portion. Since a centrifugal force from the battery to the substrate due to the rotation of the rotating portion is smaller, the influence on the substrate and the connection portion between the terminal and the substrate is smaller, which is more preferable, than that of a case where the flat secondary battery is disposed outside of the substrate. In this configuration, since a weight of the flat secondary battery is the largest among components implemented on the substrate, an electronic component can be disposed on a surface out of both surfaces of the substrate, the surface being closer to the rotation center, Thus, the influence on the substrate and other electronic components is also reduced. In this way, the long-term reliability is improved.

The rotating portion may be a rotating portion of a machine. The machine is not particularly limited as long as the machine includes a rotating portion to which device (D) is attached. Examples of the machine include a transportation machine, a production machine, a measurement machine, a machine tool, and other machines. Examples of the transportation machine include an automobile (e.g., four-wheel vehicle, motor tricycle, motorcycle, and other automobile vehicles). Examples of the production machine and the machine tool include factory automation devices (i.e., FA devices) and other production machines.

The rotating portion may be a tire. In that case, device (D) can be used in a tire monitoring system (TMS) for monitoring a pressure in the tire (i.e., tire pressure monitoring system: TPMS), monitoring a temperature in the tire, monitoring an acceleration of the tire, and other monitoring in addition to the pressure. In accordance with the purpose, device (D) includes electronic components such as necessary sensors.

In a case where the rotating portion is the tire, device (D) is fixed to an inner surface of the tire (i.e., surface that is not exposed to an outside air in use). For example, device (D) may be fixed to a wheel, a valve, a surface opposite to a ground contact surface of a tread surface of a tire, or an inner surface of a side wall surface of a tire. A method for fixing device (D) to the tire is not limited.

The tire is not particularly limited, and may be a known tire. The tire may be a tire used for various transportation machines, or may be another tire.

The rotating portion may be a rotating portion included in the factory automation device (i.e., FA device). In the case, device (D) can be used for monitoring the rotating portion and/or a surrounding situation by using a camera, monitoring a position of the rotating portion, monitoring a rotational speed of the rotating portion, monitoring a temperature of the rotating portion, and other monitoring. In accordance with the purpose, device (D) includes electronic components such as necessary sensors.

Device (D) may be fixed at any position of the rotating portion. For example, device (D) may be disposed near an outer periphery of the rotating portion. A method for fixing device (D) to the rotating portion is not limited.

Device (D) may include a housing surrounding the flat secondary battery. The housing may suppress the expansion of the flat secondary battery in a direction away from the substrate. That is, the housing may be disposed so as to suppress the expansion of the flat secondary battery in the direction away from the substrate. There may be no space or there may be a space between the housing and the flat secondary battery or the terminal.

In device (D), at least a part or all of the electronic components may be disposed on a surface where the flat secondary battery is not disposed, of both surfaces of the substrate. In such a disposition, a size and a weight of device (D) can be reduced. In a case where device (D) is attached to the rotating portion, it is particularly important to reduce the size and weight of the device from a viewpoint of balance of the rotating portion. Of course, at least a part or all of the electronic components may be disposed on a surface where the flat secondary battery is disposed.

### Method for Attaching Flat Secondary Battery

An attachment method according to the present exemplary embodiment is a method for attaching a flat secondary battery used in a device including a substrate and attached to a rotating portion. Hereinafter, the attachment method may be referred to as “attachment method (M)”. The rotator is produced by preparing device (D), preparing a rotating portion, and fixing device (D) to the rotating portion. The flat secondary battery is connected to the substrate via a terminal. The flat secondary battery includes an exterior body, and a positive electrode and a negative electrode disposed in the exterior body. The exterior body includes a positive electrode can having a bottomed cylindrical shape and a negative electrode can having a bottomed cylindrical shape. The flat secondary battery is disposed such that one (can A) of the positive electrode can and the negative electrode can having a larger expansion amount on a central axis of the exterior body faces the substrate, when the flat secondary battery expands due to a high temperature in a charging state of the flat secondary battery.

Attachment method (M) can be performed by attaching the flat secondary battery as described for device (D). Since the matters described for device (D) can be applied to attachment method (M), redundant description may be omitted. In attachment method (M), the effects described for device (D) can be obtained.

Examples of the configuration and constituent elements of device (D) according to the present exemplary embodiment will be described below. However, the configuration and configuration elements of device (D) are not limited to the following description. As described above, the following description is also applicable to attachment method (M).

### Flat Secondary Battery

The flat secondary battery is a battery having a circular planar shape, and includes a coin-shaped and button-shaped secondary battery. The flat secondary battery may be an aqueous solution secondary battery, a non-aqueous electrolyte secondary battery, a lithium secondary battery, or a lithium ion secondary battery. The lithium ion secondary battery is not particularly limited, and a known lithium ion secondary battery may be used. For example, a known coin-shaped lithium ion secondary battery using lithium titanate for the negative electrode active material may be used. A method for producing the flat secondary battery is not limited, and the flat secondary battery may be produced by a known method.

The flat secondary battery includes a positive electrode, a negative electrode, an electrolyte, and an exterior body. A separator may be disposed between the positive electrode and the negative electrode. Matters other than essential matters for the exemplary embodiment of the present disclosure are not particularly limited, and known configurations and constituent elements may be applied.

The positive electrode contains a positive electrode mixture, and the positive electrode mixture contains a positive electrode active material. A material capable of reversibly occluding and releasing lithium ions can be used as the positive electrode active material. Examples of the positive electrode active material include a composite oxide containing at least one selected from the group consisting of Ni, Co, Mn, and Al and lithium, and include, for example, lithium cobaltate, lithium manganate, a ternary nickel-manganese-lithium composite oxide, olivine type lithium iron phosphate, and lithium cobalt phosphate. The positive electrode mixture may contain various additives (e.g., a binder and a conductive material) in addition to the positive electrode active material. Alternatively, a positive electrode mixture containing only a positive electrode active material without various additives may be sintered and used as the positive electrode. The negative electrode contains a negative electrode mixture, and the negative electrode mixture contains a negative electrode active material. The negative electrode mixture may contain various additives (e.g., a binder and a conductive material) in addition to the negative electrode active material. Alternatively, a negative electrode mixture containing only a negative electrode active material without various additives may be sintered and used as the negative electrode. Each of the positive electrode and the negative electrode may be formed in a columnar shape. In addition, when the positive electrode and the negative electrode formed in a columnar shape are used, an influence of a distribution bias of the electrolyte solution due to the centrifugal force is reduced.

Lithium metal or a lithium alloy may be used as the negative electrode active material. However, in a case where the lithium metal is used, a decrease in capacity due to dendrite formation tends to occur. In a case where the lithium alloy is used, the negative electrode active material is pulverized by expansion and shrinkage of the negative electrode active material during charging and discharging to decrease the discharging capacity easily. In addition, a lithium alloy-based material is more susceptible from a viewpoint of breakage of configuration components inside the battery due to external impact and vibration. Thus, an oxide (for example, a transition metal oxide) in and from which lithium ions are occluded and released is preferably used as the negative electrode active material. The transition metal oxide contains at least a transition metal, and may contain an element other than the transition metal. The oxide (for example, transition metal oxide) of the negative electrode active material includes SiO, SnO, CuO, Cu₂O, Fe₂O₃, Fe₃O₄, ZnO, PbO, MoO, MoO₂, TiO₂, Nb₂O₅, TiNb₂O₇, Li₄Ti₅O₁₂, Li₂TiO₃, and Li_{1.4}Al_{0.4}Ti_{1.6}(PO₄)₃. Examples of the element that may be added to the oxide include at least one selected from the group consisting of Fe, Mn, Ni, Co, Sc, Y, Cu, Zn, Al, Cr, Pb, Sb, Mg, and B. Preferably, MoO, MoO₂, TiO₂, Nb₂O₅, TiNb₂O₇, Li₄Ti₅O₁₂, Li₂TiO₃, and Li_{1.4}Al_{0.4}Ti_{1.6}(PO₄)₃, which have a potential of 1 V or more with respect to metal lithium and are less likely to cause reductive decomposition of the non-aqueous electrolyte solution or the solid electrolyte, are preferable. Further, a composite oxide containing lithium and titanium having very small expansion and shrinkage (i.e., volume change) during charging and discharging may be used, or a composite oxide containing lithium and titanium may be used.

Examples of the composite oxide include lithium titanate, and specifically include lithium titanate having an initial state which is represented by Li₄Ti₅O₁₂. A part of Ti may be substituted with a different element, but a content of the different element is smaller than a content of Ti. Examples of the different element include at least one selected from the group consisting of Fe, Mn, Ni, Co, Sc, Y, Cu, Zn, Al, Cr, Pb, Sb, Mg, and B.

A non-aqueous electrolyte solution in which a lithium salt is dissolved in a non-aqueous solvent, a solid electrolyte such as an inorganic solid electrolyte such as a sulfide-based, oxide-based, or chloride-based electrolyte containing lithium, or a polymer solid electrolyte containing lithium, or an ionic liquid can be used as the electrolyte. When the solid electrolyte is used, the influence of the distribution bias of the electrolyte solution due to the centrifugal force can be completely ignored. Thus, the solid electrolyte is more preferable. A nonwoven fabric or a microporous membrane may be used as the separator. The nonwoven fabric or a microporous membrane is made of an insulating material (for example, an insulating resin) such as an olefin-based material such as polypropylene or polyethylene, an engineering plastic material such as polyphenylene sulfide or polyether ether ketone, a cellulose-based material, or an inorganic material such as glass.

The exterior body includes a positive electrode can having a bottomed cylindrical shape and a negative electrode can having a bottomed cylindrical shape. The positive electrode can and the negative electrode can are disposed to face each other via a gasket to constitute a coin-shaped or button-shaped exterior body. The positive electrode mixture is disposed in the positive electrode can, and the negative electrode mixture is disposed in the negative electrode can. Materials of the positive electrode can, the negative electrode can, and the gasket are not particularly limited, and known materials used for the positive electrode can, the negative electrode can, and the gasket may be used. A material of the gasket is preferably a material that can withstand an operating temperature (150° C. or higher) of the flat secondary battery. Examples of the material of the gasket include engineering plastics such as polyphyllesulfide (PPS), polyetheretherketone (PEEK), and a copolymer of tetrafluoroethylene and perfluoroether (PFA), and olefin-based materials. In addition, a material obtained by adding glass or a filler to the above material can also be used.

As a material of the positive electrode can and a material of the negative electrode can, the following material can be used: (I) iron, and stainless steel, (II) a clad material such as aluminum and iron, aluminum and stainless steel, and iron and copper, stainless steel and copper, and (III) nickel-plated iron, nickel-plated stainless steel, and nickel-plated clad material. In addition, the material may be at least one selected independently from the group consisting of austenitic stainless steel, two-phase stainless steel including austenitic stainless steel and ferritic stainless steel, and nickel alloy. The material of the positive electrode can and the material of the negative electrode can may be the same as or different from each other. These austenitic stainless steel, two-phase stainless steel including austenitic stainless steel and ferritic stainless steel, and nickel alloy materials have weaker magnetism than other materials. In a case where the flat secondary battery is charged by wireless power supply using electromagnetic induction such as magnetic field resonance or magnetic field coupling, an exterior can (i.e., the positive electrode can and the negative electrode can) made of a material having weak magnetism is used, and thus, the exterior can is prevented from being heated by a magnetic flux supplied for wireless power supply. As a result, it is possible to suppress the degradation of the flat secondary battery due to a temperature rise.

The positive electrode can function as a positive-electrode terminal, and the negative electrode can function as a negative-electrode terminal. A conductive layer (e.g., a carbon layer or a current collector) may be disposed between the positive electrode mixture and the positive electrode can. A conductive layer (e.g., a carbon layer or a current collector) may be disposed between the negative electrode mixture and the negative electrode can.

Can A described above is disposed to face the substrate. A bottom surface of can A is usually disposed to be substantially parallel to the substrate, but may be inclined to some extent (for example, at an angle of 30° or less) from a state of being substantially parallel to the substrate.

### Substrate

The substrate is not particularly limited as long as the substrate can stably hold the flat secondary battery. A known substrate may be used as the substrate. Examples of the substrate include a known substrate used as a printed board. In order to suppress the expansion of can A, the strength of the substrate is preferably high. In this respect, a thickness of the substrate is preferably more than or equal to 0.1 mm (for example, in a range of 0.1 mm to 2 mm). Examples of the material of the substrate include paper, resin, glass, and ceramics. The substrate may be made of at least one of these materials. Further, a material obtained by adding glass to a resin is preferably used from a viewpoint of increasing the strength of the substrate. The substrate includes a wiring.

### Electronic Component Other Than Flat Secondary Battery

In accordance with the purpose, device (D) may include an electronic component, which may constitute an electronic device, other than the flat secondary battery. Examples of such electronic components include a sensor, a camera, a power receiver, a power generating element, a transmitter, and a processor. Power is supplied from the flat secondary battery to the electronic component as necessary.

Examples of the sensor include a sensor for monitoring a position, a pressure sensor, an acceleration sensor, and a temperature sensor. The pressure sensor is used, for example, to monitor the pressure in the tire. The transmitter is an element for transmitting various types of information (for example, information obtained by the sensor) to a receiver, and includes an antenna. The processor performs various types of processing and control. For example, the processor transmits information output from the sensor via the antenna. An integrated circuit (IC) may be used as the processor.

The information transmitted from the transmitter is received by, for example, a receiver disposed in a machine body (e.g., a vehicle body or a FA device). The received information is processed and used by a control device disposed in a machine including the rotating portion.

The flat secondary battery of device (D) may be charged by wireless power supply. For example, the flat secondary battery of device (D) may be charged by wireless power supply using electromagnetic induction such as magnetic field resonance or magnetic field coupling. In the case, a power transmitter (e.g., a coil or antenna) for wireless power supply is disposed in a machine body (e.g., a vehicle body or a FA device), and device (D) includes a power receiver. The power receiver is, for example, a portion that generates power by using electromagnetic induction. Examples of the power receiver include a coil and an antenna. The flat secondary battery of device (D) may be charged by a power generating element. Examples of the power generating element include a piezoelectric element that generates power by using vibration and a Peltier element that generates power by using a temperature difference.

### Terminal

One end of a terminal (i.e., lead terminal) can be connected to each of the positive electrode can and the negative electrode can. The other end of the terminal may be connected to the electric wiring of the substrate. The shape of the terminal is not particularly limited as long as the terminal can be electrically connected. For example, a terminal made of metal such as stainless steel can be used as the terminal. In the case of the wireless power supply using electromagnetic induction such as magnetic field resonance or magnetic field coupling, a material having particularly weak magnetism is preferable. The material may be at least one selected independently from the group consisting of austenitic stainless steel, two-phase stainless steel including austenitic stainless steel and ferritic stainless steel, and nickel alloy. The materials of the positive electrode can and the negative electrode can may be the same as or different from each other. The terminal is connected to the exterior can of the flat secondary battery by, for example, resistance welding or laser welding. In addition, the terminal is connected to the substrate with solder for electrical connection between the substrate and the terminal, for example.

### Housing

Device (D) may include a housing surrounding the flat secondary battery. The housing may surround a part of device (D) or may surround entire device (D). However, in a case where the flat secondary battery is charged by using wireless power supply, the housing is selected such as wireless power supply is allowed. The housing is not particularly limited, and a housing made of metal and/or resin may be used.

Hereinafter, an example of the exemplary embodiment according to the present disclosure will be specifically described with reference to the drawings. Exemplary embodiments to be described below can be modified on the basis of the above description. In addition, the matters to be described below may be applied to the exemplary embodiment described above. In addition, the exemplary embodiments to be described below, matters that are not essential to the invention of the present disclosure may be omitted.

### First Exemplary Embodiment

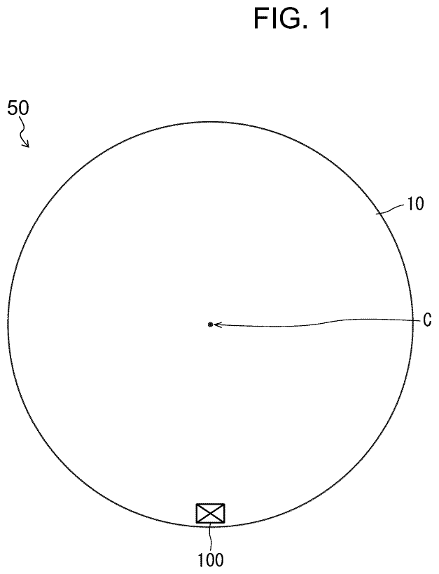

In the first exemplary embodiment, an example of device (D) and attachment method (M) will be described. FIG. 1 illustrates a side view of an example of rotating portion 10 to which device 100 is attached. In FIG. 1, only an outline of an outer edge of rotating portion 10 is illustrated. Rotator 50 includes rotating portion 10 and device 100 fixed to rotating portion 10.

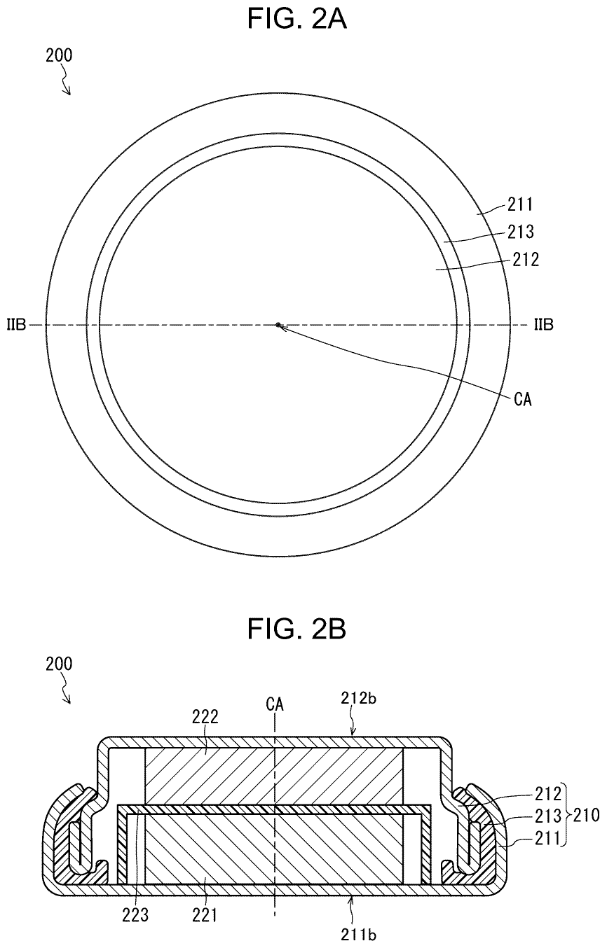

Device 100 includes flat secondary battery 200. A top view of secondary battery 200 is illustrated in FIG. 2A, and a sectional view taken along line IIB-IIB in FIG. 2A is illustrated in FIG. 2B. As illustrated in FIGS. 2A and 2B, secondary battery 200 has a coin shape (i.e., a low columnar shape). FIGS. 2A and 2B illustrate central axis CA of secondary battery 200.

Secondary battery 200 includes exterior body 210, positive electrode 221, negative electrode 222, separator 223, and a non-aqueous electrolyte. Exterior body 210 includes positive electrode can 211 having a bottomed cylindrical shape, negative electrode can 212 having a bottomed cylindrical shape, and gasket 213. Coin-shaped exterior body 210 is formed by setting positive electrode can 211 and negative electrode can 212 to face each other via a gasket.

Positive electrode can 211 includes bottom surface 211b having a circular shape and a portion having a cylindrical shape rising from an outer edge portion of bottom surface 211b. Negative electrode can 212 includes circular bottom surface 212b and a portion having a cylindrical shape rising from an outer edge portion of bottom surface 212b. In the example illustrated in FIG. 2B, at least a part of the cylindrical portion of negative electrode can 212 is disposed inside the cylindrical portion of positive electrode can 211.

Positive electrode 221 and negative electrode 222 are each formed by molding a positive electrode mixture and a negative electrode mixture into a columnar shape. Thereafter, drying is performed at a high temperature of 100° C. or higher. The positive electrode mixture contains lithium cobalt oxide as an active material, acetylene black as a conductive agent, and a fluorine-based resin of a binder. The negative electrode mixture is made of lithium titanate as an active material, acetylene black as a conductive agent, and a rubber-based material of a binder. A battery voltage in a charged state is 2.6 V. Positive electrode 221 is disposed in positive electrode can 211, and abuts on positive electrode can 211 to face the positive electrode can. Negative electrode 222 is disposed in negative electrode can 212 and abuts on negative electrode can 212 to face the negative electrode can. Separator 223 is disposed between positive electrode 221 and negative electrode 222. Separator 223, positive electrode 221, and negative electrode 222 are filled with a non-aqueous electrolyte solution.

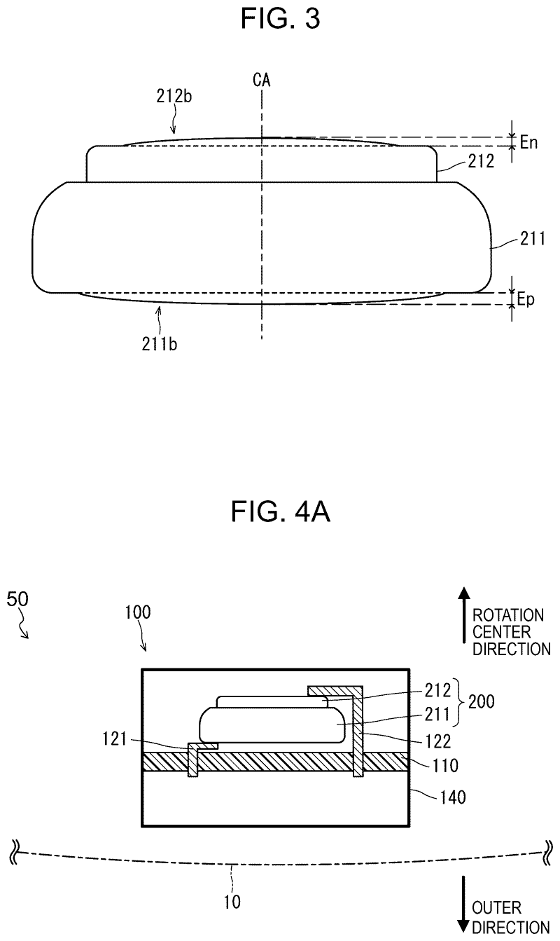

FIG. 3 schematically illustrates a side view of an example of a state where positive electrode can 211 and negative electrode can 212 each expand. A dotted line in FIG. 3 indicates the position of the bottom surface of the exterior can before expansion. For example, the dotted line in FIG. 3 indicates the position of the bottom surface of the exterior can of secondary battery 200 at normal temperature (25° C.). The exterior can may slightly expand in an initial state. Central axis CA of exterior body 210 having a columnar shape is indicated in FIG. 3. Central axis CA can be considered to correspond to a central axis of positive electrode can 211 having a bottomed cylindrical shape and a central axis of negative electrode can 212 having a bottomed cylindrical shape. Thus, central axis CA of exterior body 210 can be regarded as the central axis of positive electrode can 211 and the central axis of negative electrode can 212.

Expansion amount Ep of positive electrode can 211 on central axis CA can be obtained by measuring displacement of bottom surface 211b of positive electrode can 211 (i.e., displacement along central axis CA). Specifically, expansion amount Ep is obtained by measuring displacement of bottom surface 211b of positive electrode can 211 when the secondary battery expands due to the high temperature in the charging state from a reference position indicated by a dotted line in FIG. 3. Similarly, expansion amount En of negative electrode can 212 on central axis CA can be obtained by measuring displacement (i.e., displacement along central axis CA) of bottom surface 212b of negative electrode can 212. Specifically, expansion amount En is obtained by measuring displacement of bottom surface 212b of negative electrode can 212 when the secondary battery expands due to the high temperature in the charging state from the reference position indicated by the dotted line in FIG. 3.

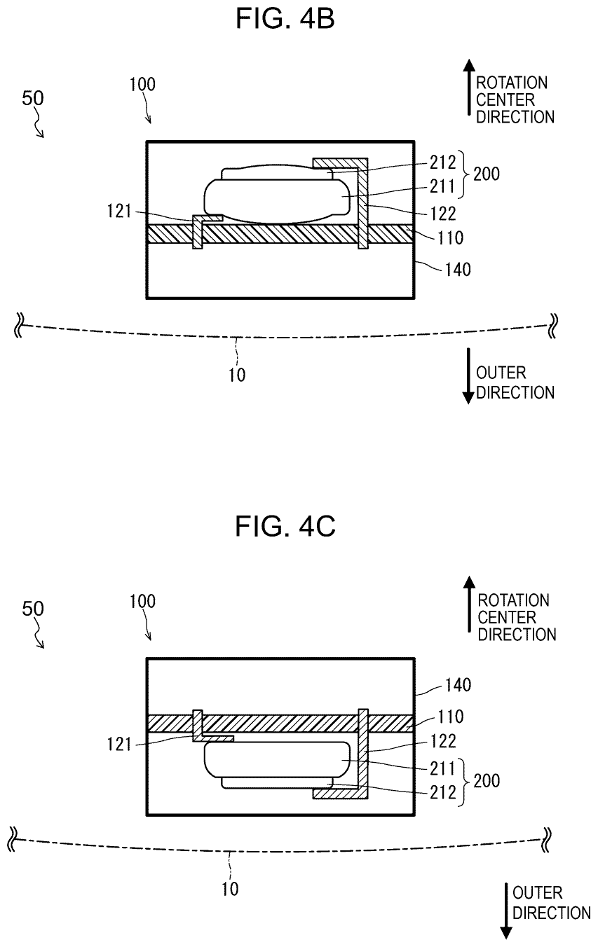

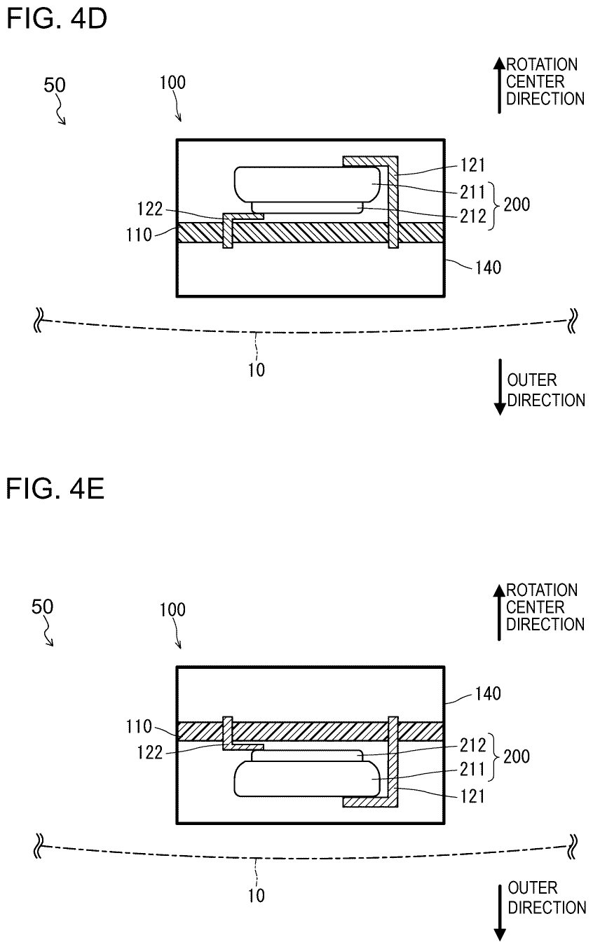

An example of the configuration and disposition of device 100 is schematically illustrated in FIG. 4A. In the following drawings, hatching is partially omitted for easy viewing of the drawing. In addition, in the following drawings, only a part of the outline of the outer edge of rotating portion 10 is illustrated. FIG. 4A illustrates an example in which can A having a large expansion amount is positive electrode can 211 and secondary battery 200 is disposed inside substrate 110, that is, secondary battery 200 is disposed closer to rotation center C than substrate 110 as viewed from rotation center C of rotating portion 10. Rotating portion 10 is configured to rotate about rotation center C.

Referring to FIG. 4A, device 100 includes substrate 110, terminals (i.e., lead terminals) 121 and 122, housing 140, and flat secondary battery 200.

Housing 140 surrounds secondary battery 200 and functions as the exterior body of device 100. Secondary battery 200 is soldered to an electric wiring of substrate 110 via terminal 121 connected to positive electrode can 211 and terminal 122 connected to negative electrode can 212. Shapes of terminals 121 and 122 and connection positions to the exterior can are not limited to the example illustrated in FIG. 4A.

In the example illustrated in FIG. 4A, secondary battery 200 is disposed inside substrate 110 as viewed from rotation center C of rotating portion 10, that is, secondary battery 200 is disposed closer to rotation center C than substrate 110. Secondary battery 200 is disposed such that positive electrode can 211 faces substrate 110. That is, the bottom surface of negative electrode can 212 is disposed closer to the rotation center C than the bottom surface of positive electrode can 211.

In the example illustrated in FIG. 4A, a state where secondary battery 200 expands is schematically illustrated in FIG. 4B. When positive electrode can 211 expands, positive electrode can 211 (specifically, the bottom surface of positive electrode can 211) contacts substrate 110 and is pushed from substrate 110. As a result, since the expansion of positive electrode can 211 having a large expansion amount can be suppressed by substrate 110, the degradation of secondary battery 200 due to the expansion of the exterior can and the dismounting of the terminal from the substrate can be suppressed.

Another example of the configuration and disposition of device 100 is schematically illustrated in FIG. 4C. FIG. 4C illustrates an example in which can A having a large expansion amount is positive electrode can 211 and secondary battery 200 is disposed outside substrate 110 as viewed from rotation center C of rotating portion 10. A mode illustrated in FIG. 4C is the same as a mode illustrated in FIG. 4A except for a positional relationship between substrate 110 and secondary battery 200, and thus, redundant description is omitted.

In the configuration illustrated in FIG. 4C, since the expansion of positive electrode can 211 having a large expansion amount can be suppressed by substrate 110, the degradation of secondary battery 200 due to the expansion of the exterior can and the dismounting of the terminal from the substrate can be suppressed.

Another example of the configuration and disposition of device 100 is schematically illustrated in FIG. 4D. FIG. 4D illustrates an example in which can A having a large expansion amount is negative electrode can 212 and secondary battery 200 is disposed inside substrate 110 as viewed from rotation center C of rotating portion 10. A mode illustrated in FIG. 4D is the same as a mode illustrated in FIG. 4A except for an orientation in which secondary battery 200 is disposed, and thus, redundant description is omitted.

In the configuration illustrated in FIG. 4D, since the expansion of negative electrode can 212 having a large expansion amount can be suppressed by substrate 110, the degradation of secondary battery 200 due to the expansion of the exterior can and the dismounting of the terminal from the substrate can be suppressed.

Another example of the configuration and disposition of device 100 is schematically illustrated in FIG. 4E. FIG. 4E illustrates an example in which can A having a large expansion amount is negative electrode can 212 and secondary battery 200 is disposed outside substrate 110 as viewed from rotation center C of rotating portion 10. A mode illustrated in FIG. 4E is the same as a mode illustrated in FIG. 4D except for a positional relationship between substrate 110 and secondary battery 200, and thus, redundant description is omitted.

In the configuration illustrated in FIG. 4E, since the expansion of negative electrode can 212 having a large expansion amount can be suppressed by substrate 110, the degradation of secondary battery 200 due to the expansion of the exterior can and the dismounting of the terminal from the substrate can be suppressed.

In PTL 1, the exterior can having a small deformation amount due to expansion during expansion is set to face the substrate, and the substrate and the flat battery are embedded in the resin. Thus, the substrate is fixed to the terminal, and a volume change to a connection portion between the substrate and the terminal is reduced. In the case of application of the disclosure of PTL 1 to the secondary battery, since the expansion amount of the secondary battery is even larger than that of the primary battery, in PTL 1, the expansion amount cannot be allowed. Thus, cracking of the resin or the substrate or dismounting of the terminal from the substrate occurs, and long-term use cannot be performed.

### Appendix

The following technologies are disclosed by the above description.

### Technology 1

A rotator comprising:
a rotating portion configured to rotate about a rotation center; and
a device fixed to the rotating portion,
wherein
the device includes a substrate and a flat secondary battery connected to the substrate with a terminal,
the flat secondary battery includes an exterior body, and a positive electrode and a negative electrode disposed in the exterior body,
the exterior body includes a positive electrode can having a bottomed cylindrical shape and a negative electrode can having a bottomed cylindrical shape, and
the flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

### Technology 2

The rotator according to Technology 1, wherein
the flat secondary battery is disposed outside the substrate as viewed from the rotation center of the rotating portion.

### Technology 3

The rotator according to Technology 1 or 2, wherein
the rotating portion is a tire.

### Technology 4

The rotator according to Technology 1 or 2, wherein
the rotating portion is a rotating portion included in a factory automation device.

### Technology 5

The rotator according to any one of Technologies 1 to 4, further comprising:
a housing that covers the flat secondary battery,
wherein
the housing is configured to suppress expansion of the flat secondary battery in a direction away from the substrate.

### Technology 6

A method for producing a rotator, comprising:
preparing a rotating portion;
preparing a device including a substrate and a flat secondary battery; and
fixing the device to the rotating portion,
wherein
the flat secondary battery is connected to the substrate with a terminal,
the flat secondary battery includes an exterior body, and a positive electrode and a negative electrode disposed in the exterior body,
the exterior body includes a positive electrode can having a bottomed cylindrical shape and a negative electrode can having a bottomed cylindrical shape, and
the flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

### Technology 7

The method according to Technology 6, wherein
the rotating portion is configured to rotate about a rotation center, and
the fixing of the device to the rotating portion includes fixing the device to the rotating portion to allow the flat secondary battery to be disposed outside the substrate as viewed from the rotation center of the rotating portion.

### Technology 8

The method according to Technology 6 or 7, wherein
the rotating portion is a tire.

### Technology 9

The method according to Technology 6 or 7, wherein
the rotating portion is a rotating portion included in a factory automation device.

### Technology 10

The method according to any one of Technologies 6 to 9, wherein
the device further includes a housing that covers the flat secondary battery, and
the housing is configured to suppress expansion of the flat secondary battery in a direction away from the substrate.

### INDUSTRIAL APPLICABILITY

The present disclosure can be used for a rotator including a device attached to a rotating portion, and a method for producing a rotator.

### REFERENCE MARKS IN THE DRAWINGS

10 rotating portion
50 rotator
100 device
110 substrate
121, 122 terminal
140 housing
200 secondary battery (e.g., flat secondary battery)
210 exterior body
211 positive electrode can
212 negative electrode can
213 gasket
221 positive electrode
222 negative electrode
CA central axis

1. A rotator comprising:
a rotating portion configured to rotate about a rotation center; and
a device fixed to the rotating portion,
wherein
the device includes a substrate and a flat secondary battery connected to the substrate with a terminal,
the flat secondary battery includes an exterior body, and a positive electrode and a negative electrode disposed in the exterior body,
the exterior body includes a positive electrode can having a bottomed cylindrical shape and a negative electrode can having a bottomed cylindrical shape, and
the flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

2. The rotator according to claim 1, wherein
the flat secondary battery is disposed outside the substrate as viewed from the rotation center of the rotating portion.

3. The rotator according to claim 1, wherein
the rotating portion is a tire.

4. The rotator according to claim 1, wherein
the rotating portion is a rotating portion included in a factory automation device.

5. The rotator according to claim 1, further comprising:
a housing that covers the flat secondary battery,
wherein
the housing is configured to suppress expansion of the flat secondary battery in a direction away from the substrate.

6. A method for producing a rotator, comprising:
preparing a rotating portion;
preparing a device including a substrate and a flat secondary battery; and
fixing the device to the rotating portion,
wherein
the flat secondary battery is connected to the substrate with a terminal,
the flat secondary battery includes an exterior body, and a positive electrode and a negative electrode disposed in the exterior body,
the exterior body includes a positive electrode can having a bottomed cylindrical shape and a negative electrode can having a bottomed cylindrical shape, and
the flat secondary battery is disposed in such a manner that one of the positive electrode can and the negative electrode can having a larger expansion amount on a central axis of the exterior body than the other of the positive electrode can and the negative electrode can faces the substrate, when the flat secondary battery expands due to a high temperature in a charging state of the flat secondary battery.

7. The method according to claim 6, wherein
the rotating portion is configured to rotate about a rotation center, and
the fixing of the device to the rotating portion includes fixing the device to the rotating portion to allow the flat secondary battery to be disposed outside the substrate as viewed from the rotation center of the rotating portion.

8. The method according to claim 6, wherein
the rotating portion is a tire.

9. The method according to claim 6, wherein
the rotating portion is a rotating portion included in a factory automation device.

10. The method according to claim 6, wherein
the device further includes a housing that covers the flat secondary battery, and
the housing is configured to suppress expansion of the flat secondary battery in a direction away from the substrate.
